(19) United States
(12) Patent Application Publication
(10) Pub. No.: US 2025/0219334 A1
(43) Pub. Date: Jul. 3, 2025

(54) Lighted Plug Grip Device

(71) Applicants: Jon Treat, Oklahoma City, OK (US); Ryan Egbert, Oklahoma City, OK (US); Corey Langston, Oklahoma City, OK (US); Kali Smith, Oklahoma City, OK (US); Tyler Worsham, Oklahoma City, OK (US)

(72) Inventors: Jon Treat, Oklahoma City, OK (US); Ryan Egbert, Oklahoma City, OK (US); Corey Langston, Oklahoma City, OK (US); Kali Smith, Oklahoma City, OK (US); Tyler Worsham, Oklahoma City, OK (US)

(21) Appl. No.: 18/400,743

(22) Filed: Dec. 29, 2023

(51) Int. Cl. H01R 13/717; H01R 13/58; H01R 25/00

(52) U.S. Cl. CPC H01R 13/7175; H01R 13/5845; H01R 25/003

(57) ABSTRACT

The present invention relates in general to electrical power extension cords, and in particular to electrical power extension cords with improved features, which include: handling, illumination, and functionality. The invention comprises an electrical power supply cord containing a central ring within a housing of a receptacle and/or within the housing of an electrical plug. The central ring provides illumination to an ambient area. Embodiments described for the present invention comprise an electrical plug, a receptacle electrically connected to the plug, a central ring within a housing of the receptacle, whereas the central ring comprises: at least one LED light, an optical element comprised of translucent material, whereas the at least one LED light is configured to provide ambient light, whereas the central ring is perpendicular to a face of the receptacle, and the central ring creates an aperture through the housing of the receptacle.

### BACKGROUND OF THE INVENTION

### 1. Field of the Invention

The present invention relates in general to electrical power extension cords, and in particular to electrical power extension cords with improved features, which include: handling, illumination, and functionality.

### 2. Description of the Related Art

Electrical power extension cords, typically, are comprised of a plug at one end of an electrical cord and one or more receptacles at another end. Often, the plug is inserted into an AC power outlet, however, other types of electrical cabling may be referred to as an extension cord. The cord may be of varying lengths, diameter, and composition.

Extension cords may also incorporate a variety of safety features, such as: grounded terminals, power indicators, or polarized plugs and receptacles.

Prior art discloses a cover assembly for an electrical connector at the end of a sheathed cable containing several insulated wires. An insulation piercing clip couples light bulb leads to the wires. A housing encloses the light bulb, said insulation piercing clip, the entire section of unsheathed insulated wires, a portion of the electrical connector, and a portion of the sheathed cable. The cover assembly is illuminated by the light bulb when power flows through the electrical connector and may be color coded to indicate connector function.

### SUMMARY OF THE INVENTION

The present invention comprises an electrical power supply cord containing a central ring within a housing of a receptacle and/or within the housing of an electrical plug. The central ring provides illumination to an ambient area.

Embodiments described for the present invention comprise an electrical plug, a receptacle electrically connected to the plug, a central ring within a housing of the receptacle, whereas the central ring comprises: at least one LED light, an optical element comprised of translucent material, whereas the at least one LED light is configured to provide ambient light, whereas the central ring is perpendicular to a face of the receptacle, and the central ring creates an aperture through the housing of the receptacle.

One embodiment comprises an electrical plug, a central ring within a housing of the electrical plug, whereas the central ring within the housing of the electrical plug comprises: at least one LED light, an optical element comprised of translucent material, whereas the at least one LED light is configured to provide ambient light; and whereas the central ring is perpendicular to a face of the electrical plug, and the central ring creates an aperture through the housing of the electrical plug.

Another embodiment comprises an electrical plug, a receptacle electrically connected to the plug, a housing of the receptacle, whereas the housing of the receptacle comprises at least one of the following: a trigger notch, a rotating central hole, or a pivoting handle.

It should be appreciated that combinations of the foregoing concepts and additional concepts discussed in greater detail below are contemplated as being part of the inventive subject matter disclosed herein. In particular, all combinations of claimed subject matter appearing at the end of this disclosure, or elsewhere herein, are contemplated as being part of the inventive subject matter.

These and other systems, methods, objects, features, and advantages of the present invention will be apparent to those skilled in the art from the following detailed description of the preferred embodiment and the drawings.

### BRIEF DESCRIPTION OF THE DRAWINGS

One or more embodiments are illustrated by way of example, and not by limitation, reference will now be made to the accompanying drawings, having the same numeral designations to represent like elements throughout and wherein:

FIG. 1 shows a perspective view of an embodiment of a device;

FIG. 2 shows a perspective view of an embodiment of a device;

FIG. 3 shows a front elevational view of an embodiment of a device;

FIG. 4 shows a rear sectional view of an embodiment of a device;

FIG. 5 shows a left side plan view of an embodiment of a device;

FIG. 6 shows a right side plan view of an embodiment of a device;

FIG. 7 shows a bottom plan view of an embodiment of a device;

FIG. 8 shows a top plan view of an embodiment of a device;

FIG. 9 shows a sectional view of an embodiment of a device;

FIG. 10 shows a perspective view of an embodiment of a device;

FIG. 11 shows a left side plan view of an embodiment of a device;

FIG. 12 shows a right side plan view of an embodiment of a device;

FIG. 13 shows a left side plan view of an embodiment of a device;

FIG. 14 shows a right side plan view of an embodiment of a device;

FIG. 15 shows a left side plan view of an embodiment of a device; and

FIG. 16 shows a right side plan view of an embodiment of a device.

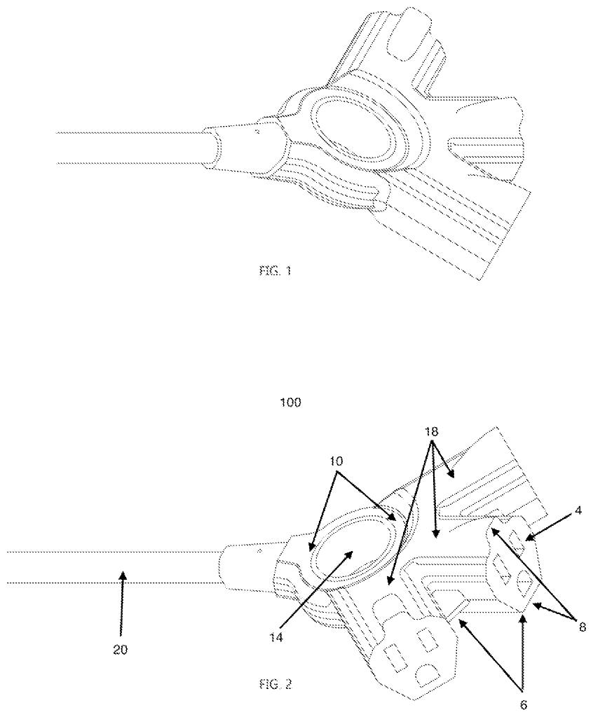

While the invention has been described in connection with certain preferred embodiments, other embodiments would be understood by one of ordinary skill in the art and are encompassed herein.

Elements with corresponding reference numerals:
Electrical outlet device 100
Plug 2
Receptacle 4
Housing of receptacle 6
Face of receptacle 8
Receptacle central ring 10
LED light 12
Optical element 14
Receptacle central ring aperture 16
Multiple receptacle configuration 18
Cord 20
Plug optical element 22
Junction point 24
Cord angle guide 26
Housing of plug 28
Face of plug 30
Trigger notch 32
Plug central ring 34
Plug central ring aperture 36

### DETAIL DESCRIPTION OF THE INVENTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in order to facilitate describing the subject innovation. Moreover, it is to be appreciated that the drawings may not be to scale.

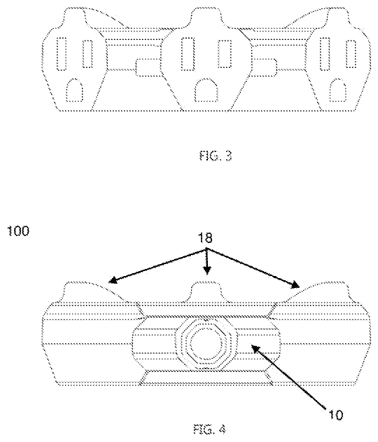

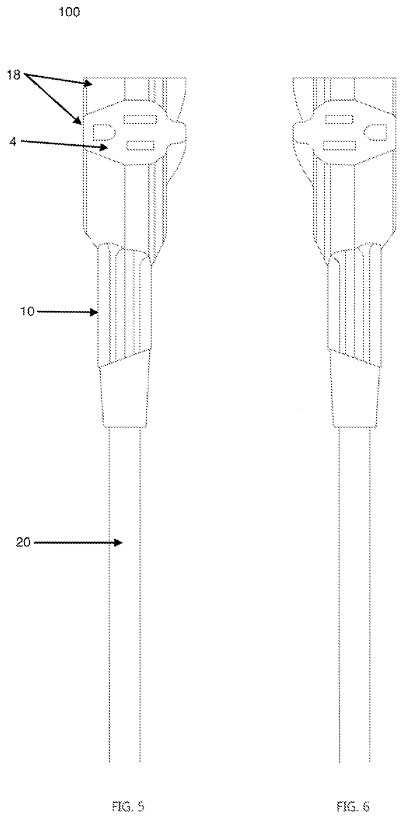

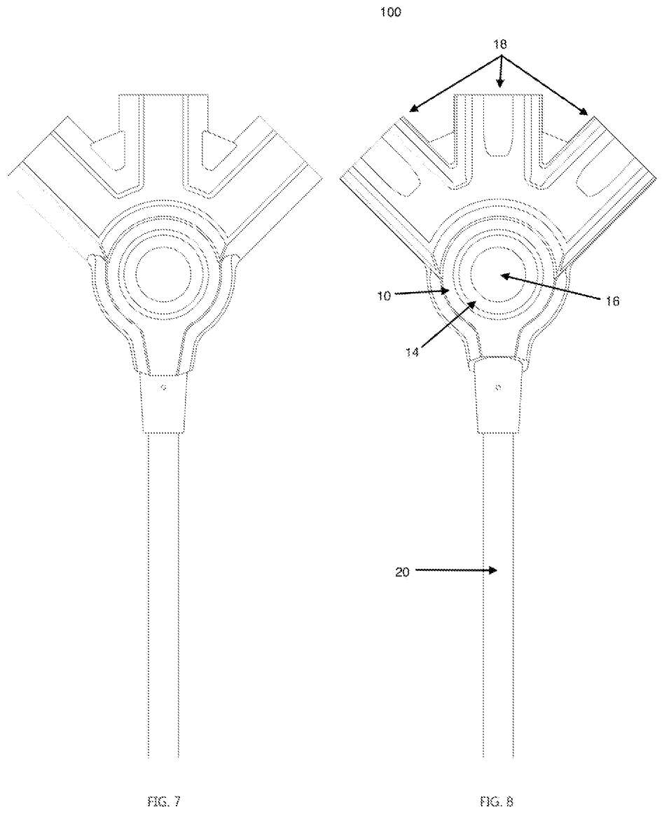

FIG. 2 shows a perspective view of an embodiment of a device. The device 100 may include a variety of components. In this embodiment, a cord 20 electrically connects to a receptacle central ring 10. The receptacle central ring is comprised of a central ring body, LED lights (not shown), and a receptacle optical element 14. The receptacle optical element may be composed of translucent material. The ring 10 is electrically connected to at least one receptacle 4. In FIG. 2, the device 100 is a multiple receptacle configuration 18, comprised of three receptacles. A housing of the receptacle 6 may extend from the cord 20 to the face of the at least one receptacle 4.

The receptacle optical element 14 may be comprised of varying materials. The optical element may be of varying degrees of opaqueness, including transparent. The shape of the optical element 14 may vary, including: convex, concave, irregular, and linear or straight. The optical element may include an illustration, logo, design, or scene.

In this embodiment, the receptacle optical element 14 is configured to be in the interior circumference of the receptacle central ring 10. Alternate embodiments may be comprised of the optical element on the outer circumference of the central ring 10, and/or at different locations within and/or about the housing of the receptacle.

FIGS. 4 and 5 show a rear sectional view and a left side plan view of an embodiment of a device. In this embodiment, the multiple receptacle configuration 18 comprises three receptacles which reduce in width at the area in which the receptacles meet the central ring 10. The reduction in thickness of the receptacle central ring facilitates an easier handling of the device 100. When the device is lying flat on a surface, ground, floor, etc., the reduced thickness of the receptacle central ring 10 permits a user to more easily grab the device from the bottom, side, and/or top of the ring 10. In alternate embodiments, such as a singular outlet configuration, the receptacle 4 may reduce in width at the area in which the receptacle meets the receptacle central ring 10.

FIG. 8 shows a top plan view of an embodiment of a device. A receptacle central ring aperture 16 is created by the inner space formed within the receptacle central ring 10. The device 100 may be held by placing a user's fingers and/or thumb on the outer periphery of the receptacle central ring and/or within the aperture 16.

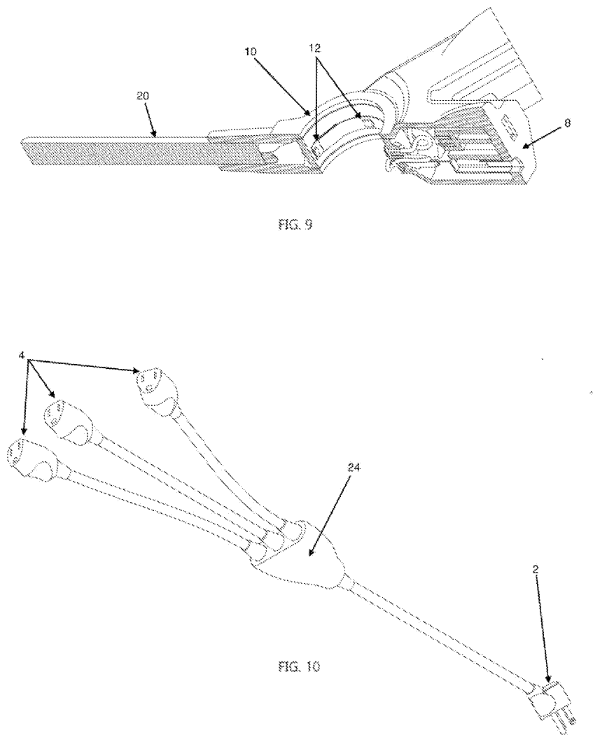

FIG. 9 shows a sectional view of an embodiment of a device. The central ring within the housing of the electrical plug comprises at least one LED light 12. The at least one LED lights are spatially configured within the central ring. The at least one LED light 12 produces light which is diffused by an optical element (not shown). The diffusion of light by the optical element produces ambient light. The LEDs may have color changing capabilities, or may be dimmable.

FIG. 10 shows a perspective view of an embodiment of a device. In this embodiment, more than one receptacle 4 is electrically connected to a plug 2. A plug is electrically connected to a cord that splits into more than one cord at a junction point 24. The device comprises more than one housing of a receptacle each connected to a cord extending from the junction point. Embodiments may be comprised of a trigger notch, and/or contain a central ring within the receptacle housing body.

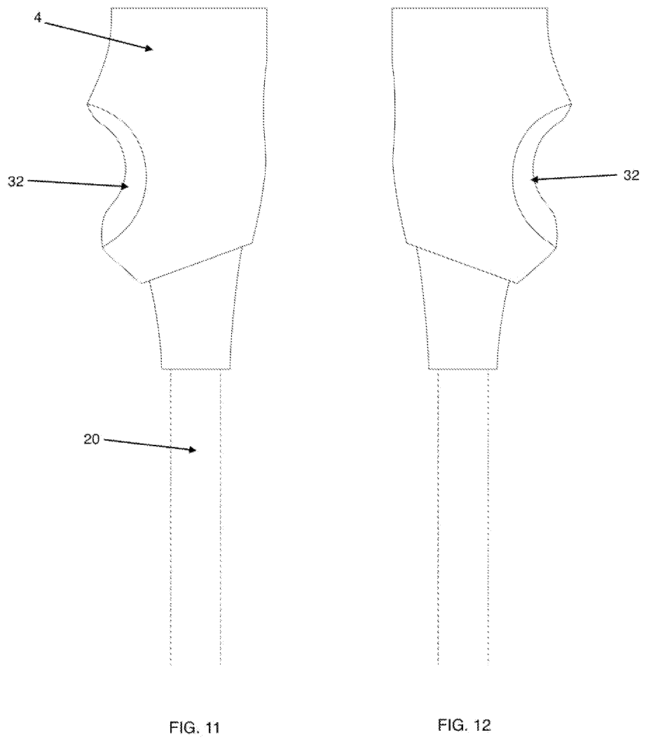

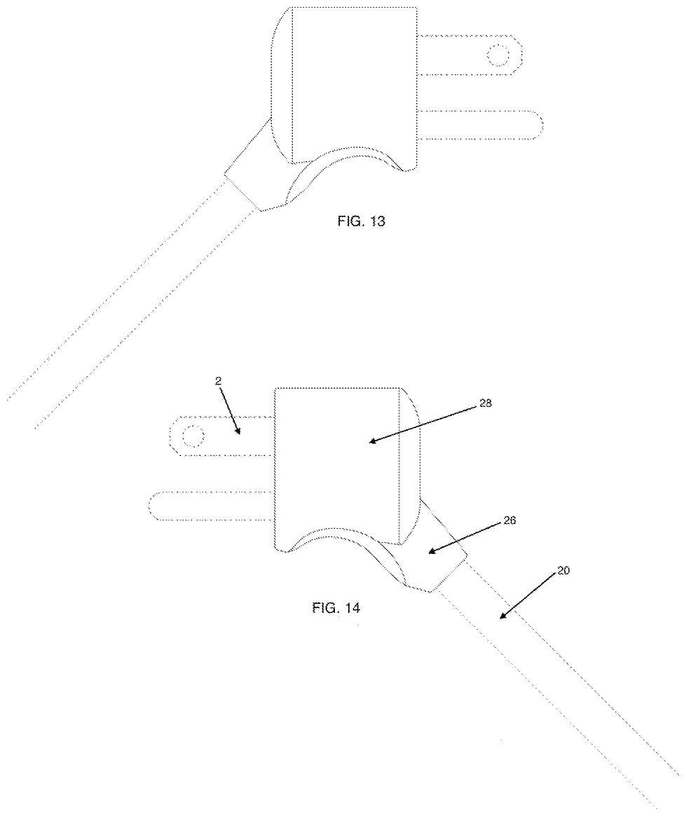

FIG. 11 shows a left side plan view of an embodiment of a device. In this embodiment, the device comprises a receptacle electrically connected to a plug (not shown), a housing of the receptacle, and a trigger notch 32. The trigger notch indents within the housing of the receptacle, permitting a natural hand grip position around the housing of the receptacle.

FIG. 14 shows a right side plan view of an embodiment of a device. In this embodiment, the housing of the electrical plug 28 contains a cord angle guide 26. The cord angle guide 26 attaches to the housing of the plug and directs an electrical cord away at an angle. The cord angle guide and the housing 28 may be constructed as one piece, or the cord angle guide may connect to the housing 28 as an attachment. Alternate embodiments may have the cord angle guide directing the cord at different angles. The cord angle guide may direct the cord away from the housing of the electrical plug parallel to the vertical axis of a face of the plug or at an angle in relation to the vertical axis.

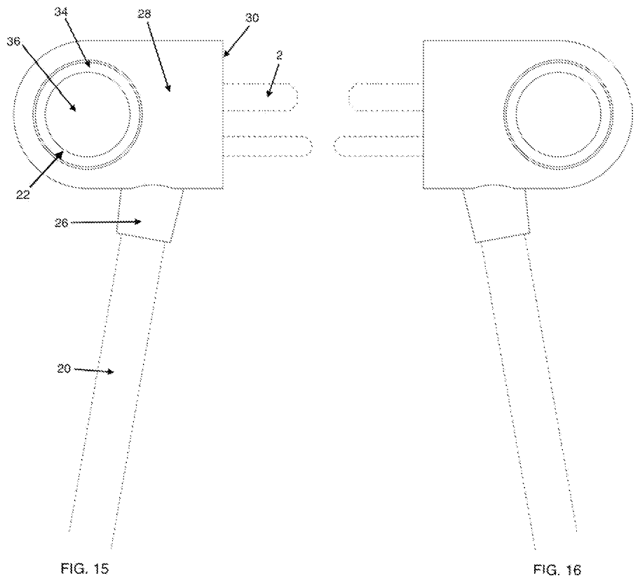

FIG. 15 shows a left side plan view of an embodiment of a device. A housing of an electrical plug 28 comprises a plug housing central ring 34 electrically connected to a plug 2. The plug housing central ring 34 contains at least one LED light (not shown) and a plug optical element 22 comprised of translucent material. The at least one LED light is configured to provide ambient light. The central ring 34 is perpendicular to a face of the electrical plug 30, and the central ring 34 creates an aperture through the housing of the plug 28.

The plug optical element 22 may be comprised of varying materials. The optical element may be of varying degrees of opaqueness, including transparent. The shape of the plug optical element 22 may vary, including: convex, concave, irregular, and linear or straight. The optical element may include an illustration, logo, design, or scene. In this embodiment, the plug optical element 22 is configured to be in the interior circumference of the receptacle central ring 10. Alternate embodiments may be comprised of the optical element on the outer circumference of the central ring 10, and/or at different locations within and/or about the housing of the plug.

The at least one Led light within the housing of the plug 28 is spatially configured to produce ambient light. The light produced by the at least one LED light is diffused by the plug optical element 22.

Embodiments include a housing of an outlet comprising a pivoting handle. The pivoting handle articulates away from one end of the rear of a housing of a receptacle. When the pivoting handle is not being utilized, the handle may be in a resting position. A rear receptacle body protuberance is configured to protect the handle and improve functionality of the device. While the handle is in the resting position, the rear outlet protuberance completes and fills an empty void created by the handle. In alternate embodiments, the pivoting handle may be located on a different side of the housing of the receptacle.

Alternate embodiments include a housing of a receptacle comprising a rotating central ring. The rotating receptacle inner section may be cylindrical. The inner section may rotate around a horizontal axis of a face of a receptacle. The rotating receptacle inner section may comprise an outlet central ring, trigger notch, or pivoting handle. In another embodiment, the housing of the receptacle comprises a rotating receptacle end, whereas the inner section of the body remains fixed and the outlet end is configured to rotate around a horizontal axis of the body of the outlet.

Although the present invention has been described in relation to particular embodiments thereof, many other variations and modifications will become apparent to those skilled in the art. It is preferred, therefore, that the present invention be limited not by the specific disclosure herein, but only by the appended claims. Alternate embodiments may be devised without departing from the spirit or scope of the invention. Further, the particular feature or structure may be combined in any suitable manner in one or more embodiments.

What is claimed is:

1. An electrical power supply cord device, comprising:
an electrical plug;
a receptacle electrically connected to the electrical plug;
a housing of the receptacle;
a face of the receptacle;
a central ring within the housing of the receptacle;
the central ring within the housing of the receptacle comprises:
at least one LED light;
an optical element comprised of translucent material;
whereas the at least one LED light is configured to provide ambient light; and
whereas the central ring within the housing of the receptacle is perpendicular to the face of the receptacle, and the central ring within the housing of the receptacle creates an aperture through the housing of the receptacle.

2. The electrical power supply cord device of claim 1, further comprising:
more than one receptacle electrically connected to the electrical plug; and
whereas the housing of the receptacle comprises the more than one receptacle electrically connected to the electrical plug.

3. The electrical power supply cord device of claim 1, further comprising:
a housing of the electrical plug;
a face of the electrical plug;
a central ring within the housing of an electrical plug;
the central ring within the housing of an electrical plug comprises:
at least one LED light;
an optical element comprised of translucent material;
whereas the at least one LED light is configured to provide ambient light; and
whereas the central ring within the housing of an electrical plug is perpendicular to the face of an electrical plug, and the central ring within the housing of the electrical plug creates an aperture through the housing of the electrical plug.

4. The electrical power supply cord device of claim 1, further comprising:
a housing of the electrical plug;
a face of the electrical plug;
a central ring within the housing of the electrical plug;
the central ring within the housing of the electrical plug comprises:
at least one LED light;
an optical element comprised of translucent material;
whereas the at least one LED light is configured to provide ambient light;
whereas the central ring within the housing of the electrical plug is perpendicular to the face of the electrical plug, and the central ring creates an aperture through the housing of the electrical plug;
a cord;
the housing of the electrical plug contains a cord angle guide, whereas the cord angle guide directs the cord at an angle away from the electrical plug.

5. The electrical power supply cord device of claim 1, further comprising:
a housing of the electrical plug, whereas the housing of the electrical plug contains a trigger notch.

6. The electrical power supply cord device of claim 1, further comprising:
a housing of the electrical plug, whereas the housing contains a trigger notch; and
the housing of the electrical plug contains a cord angle guide, whereas the cord angle guide directs the cord at an angle away from the electrical plug.

7. An electrical power supply cord device, comprising:
an electrical plug;
a housing of the electrical plug;
a face of the electrical plug;
a central ring within the housing of the electrical plug;
the central ring within the housing of the electrical plug comprises:
at least one LED light;
an optical element comprised of translucent material;
whereas the at least one LED light is configured to provide ambient light; and
whereas the central ring within the housing of the electrical plug is perpendicular to the face of the electrical plug, and the central ring creates an aperture through the body of the electrical plug.

8. The electrical power supply cord device of claim 7, further comprising:
whereas the central ring within the housing of the electrical plug is rotated 90 degrees along a horizontal axis of the plug;
whereas the central ring is perpendicular to the face of the plug, and the central ring creates a vertical aperture through the housing of the plug.

9. The electrical power supply cord device of claim 7, further comprising:
the housing of the electrical plug contains a cord angle guide, whereas the cord angle guide directs the cord at an angle away from the electrical plug.

10. The electrical power supply cord device of claim 7, further comprising:
more than one receptacle electrically connected to the electrical plug;
a housing of the more than one receptacle;
a face of the more than one receptacle;
a central ring within the housing of the more than one receptacle;
the central ring comprises:
at least one LED light;
an optical element comprised of translucent material; and
whereas the at least one LED light is configured to provide ambient light; and
whereas the central ring within the housing of the more than one receptacle is perpendicular to the face of the more than one receptacle, and the central ring creates an aperture through the housing of the more than one receptacle.

11. An electrical power supply cord device, comprising:
an electrical plug;
at least one receptacle electrically connected to the electrical plug;
a housing of the electrical plug; and
whereas the housing of the electrical plug comprises a trigger notch.
